(19) United States
(12) Patent Application Publication
(10) Pub. No.: US 2005/0008444 A1
(43) Pub. Date: Jan. 13, 2005

(54) Limited-torque plastic screw for attaching column-mounted elements of liquid-level gauges and feeding liquids thereto

(75) Inventor: Alberto Bertani, Milano (IT)

Correspondence Address: PEARNE & GORDON LLP, 1801 EAST 9TH STREET, SUITE 1200, CLEVELAND, OH, 44114-3108, US

(73) Assignee: ELESA, S.p.A., Milano (IT)

(21) Appl. No.: 10/871,950

(22) Filed: Jun. 18, 2004

(30) Foreign Application Priority Data
Jul. 9, 2003 (IT) 000320/2003(U)

(51) Int. Cl. F16B 31/00

(52) U.S. Cl. 411/2

(57) ABSTRACT

A limited-torque screw, designed for fastening column-mounted elements of liquid-level gauges and for feeding liquids to the elements, is provided over the length of its shaft with a blind axial bore and near its head with a transverse hole that intersects with the axial bore. The screw is molded from a synthetic plastic material and a slot provided in its head for the insertion of a screwdriver features a laterally curved bottom. The screw is produced in molds that generate a smooth mirror finish on the surfaces that define the blind axial bore and the transverse hole while allowing the thread of the screw to have a curved profile. The radius of the curved areas between the bottom and the sides of the screwdriver slot in the head of the screw is about one quarter the width of the slot.

### BACKGROUND OF THE INVENTION

The present invention relates to a limited-torque screw, in particular for attaching column-mounted elements of liquid-level gauges and for feeding liquids to said elements.

In the technical realm, liquid-level gauges have been known that comprise a hollow, transparent, column-mounted synthetic polymer element perhaps in conjunction with a graduated scale, which is attached and fed the liquid whose level is to be monitored, for instance in a reservoir, by means of a connection employing special screws whose shafts are provided over their full length with blind axial bores and near their head with a transverse through-hole that intersects with the axial bore. These special screws have always been made out of metal and have to be machined at least for the bore, the hole and the screwdriver slot in the head. These are thus components that are difficult and expensive to make and, most of all, they display a few flaws both in the ultimate mounting of the gauges and in the functional performance of these gauges.

With regard to the former aspect, it is easily possible that in the mounting process, directly on the reservoir containing the liquid whose level is to be monitored, too much torque is applied, thus leading either to incorrect pressure levels of the equipment or, in some cases, to actual breaks in the synthetic polymer column with an annoying loss of liquid, or in certain cases even to irreparable damage to the gauge.

With regard to the latter, it is difficult to shape the holes in the screws, constituting conduits for the liquid whose level is to be indicated, with the desired surface smoothness, at least not without requiring complex and very costly postprocessing.

### BRIEF SUMMARY OF THE INVENTION

The present invention provides a screw for attaching column-mounted liquid-level gauge elements and for feeding liquid to said elements. The screw is characterized in that it is molded from a synthetic plastic and that the screwdriver slot in its head features a bottom that transitions to the sides via curved areas.

According to the present invention, the screw is produced in a mold that generates a mirror finish on the surfaces that define the axial blind bore and the transverse through-hole while also making it possible to give the thread of the screw a curved profile.

The radius of the curved connecting section between the bottom and the sides of the screwdriver slot in the head of the screw according to the present embodiment of the invention is about one fourth the width of the slot.

### BRIEF DESCRIPTION OF THE DRAWINGS

The following describes one embodiment of the screw according to the present invention in more detail, strictly as an example, with reference to the attached drawing.

FIG. 1 is an illustration, with parts of the head in cross section, of the screw according to the present invention;

FIG. 2 is an axial sectional view rotated 180 from FIG. 1;

FIG. 3 is a top view of the head of FIG. 1;

FIG. 4 and 5 are perspective views of the screw of FIGS. 1-3,

FIG. 6 and 7 show, at a smaller scale, how the blade of a screwdriver is inserted in the screw of FIGS. 1-5;

FIG. 8 shows a detail, at a highly enlarged scale, of the head of a screw according to the present invention, with the screwdriver set in the slot provided therein; and

FIG. 9 shows a level gauge, mounted on a synthetic polymer column including two screws according to the present invention.

### DETAILED DESCRIPTION OF THE INVENTION

Referring to the drawings, FIG. 9 shows a liquid-level gauge D comprising a hollow column element A consisting of a transparent synthetic polymer and attached to a graduated metal scale, whereby the attachment and the feed-in of the liquid whose level is to be monitored, for instance in a reservoir, are accomplished by means of a connection using special screws V. In conventional fashion and as indicated above, these screws V are provided with a blind axial bore over the length of their shafts and with a transverse through-hole that intersects with the axial bore near the head of the screw.

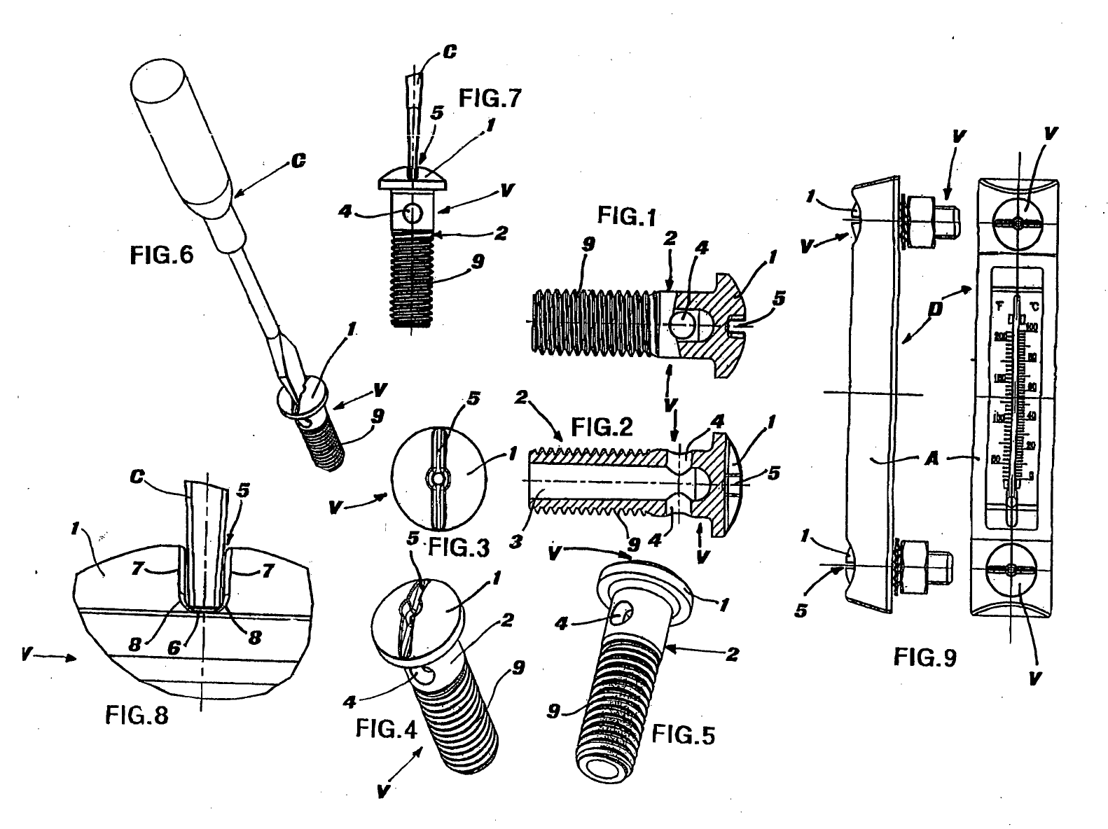

According to the invention, the special screws V—one embodiment of which is shown in FIGS. 1-8—are molded from a synthetic plastic material in the same shape as has been used to date for metal screws serving the same purpose, i.e. with a head 1 and shaft 2, said shaft 2 having a blind axial bore 3 and near the head 1 a transverse through-hole 4 that intersects with the axial bore 3, but with a significant feature in that the slot 5 for inserting the screwdriver C in the head 1 of the screw V has a bottom 6 (see in particular FIG. 8) that transitions to the sides 7 via a curved section 8. In conventional fashion the shaft is provided with a thread 9 that ends at a certain distance from the head 1.

According to the invention the screws V are produced in a mold that generates a smooth mirror finish on the surfaces defining the blind axial bore 3 and the transverse through-hole 4 while allowing the thread 9 to be given a curved profile.

In the present embodiment of the invention, for reasons explained further below, the radius of the curved transitional areas 8 between the bottom 6 and the sides 7 of the slot 5 for the screwdriver C is selected to be about one fourth the width of the slot. For example, if the width of the screwdriver slot 5 in the head 1 is equal to about 2 mm, the curved transitional areas 8 between the bottom 6 and the sides 7 of the screw V will have a radius of curvature of 0.5-0.6 mm.

The screw according to the present invention has a few advantages that will be obvious enough by virtue of the fact that it is made from a plastic material: It naturally offers good resistance to corrosion and to atmospheric agents that metal screws can attain only with an expensive electroplating process, unless they are in the form of even more expensive stainless-steel screws; they are easy to produce in different colors for final product identification; they cost considerably less compared to metal screws of the same shape; and so on.

Compared to conventional metal screws, the screws of the present invention offer even substantially more important properties that derive not so much from the well known properties of synthetic plastic of which they consist, but instead from the particular design features given them in the molding process according to the present invention.

First of all, the screw is a limited-torque screw, meaning that, as it is tightened, its compressive force is limited: Due to the curved transitions 8 between the bottom 6 and the sides 7 of the slot 5 for the screwdriver C in the screw V, and to the intrinsic elasticity, resilience and deformability of the plastic material from which the screw is made, the screwdriver C will in fact slip out of its seat (slot 5) during the tightening operation after having ensured an optimal torque for holding the components in place. For example, when mounting the level gauge D of FIG. 9, the tightness needed for holding the hollow column A to the gauge is obtained while avoiding any possible breakage, without having to apply any particular caution. Note that, when using corresponding special metal screws, a brochure must be supplied to the end user indicating the recommended maximum torque for mounting the level gauge. This adds complications and delays to the mounting process, and still does not eliminate all possible problems. The guarantee not to break the hollow column A of the gauge provided by the special plastic screws of the present invention prevents any possible unwanted leakage of liquid from the reservoir on which the gauge is mounted. They also prevent possible resulting damage of a technical and/or environmental nature.

Other significant advantages of the invention derive from the special characteristics which, according to the invention, are attributed to the molds in which the screws are produced: By generating a shiny mirror finish on the surfaces of the screw that define the blind axial bore and the transverse hole, the holes through which the liquid flows attain a particularly smooth surface which, again for example in the case of the level gauge, facilitates and accelerates the entry and exit of the liquid, avoiding dangerous blockages by impurities, while a curved profile on the thread of the screw greatly facilitates the mounting, avoiding possible jamming due to burrs on the edges that are typical of metal screws.

Of course, the present invention includes in its scope screws that provide the same capabilities, especially screws as described whose head, as the above head 1, is provided not with a simple slot of 5 for the insertion of a flat-blade screwdriver C but instead with a Philips-type or socket seat suitably molded using corresponding equipment.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

1. A limited-torque screw for attaching column-mounted elements of liquid-level gauges and for feeding liquids to said elements, the screw comprising:
a head;
a shaft extending from the head;
a blind axial bore extending longitudinally through the shaft of the limited-torque screw;
a transverse through-hole proximate a head of the limited-torque screw, the through-hole intersecting with the axial bore; and
a screwdriver slot in the head having a bottom that connects to sides via curved transitional sections,
wherein the limited-torque screw is molded from a plastic material.

2. The limited-torque screw of claim 1, wherein the limited-torque screw is produced in a mold that provides a mirror finish on surfaces that define the blind axial bore and the transverse through-hole.

3. The limited-torque screw of claim 1, wherein the shaft comprises a thread and the limited-torque screw is produced in a mold that provides the thread with a curved profile.

4. The limited-torque screw of claim 1, wherein a radius of the curved transitional sections is about one fourth of a width of the screwdriver slot.
